(19) United States
(12) Patent Application Publication
(10) Pub. No.: US 2023/0343342 A1
(43) Pub. Date: Oct. 26, 2023

(54) DETECTING AUDIO DEEPFAKES THROUGH ACOUSTIC PROSODIC MODELING

(71) Applicant: University of Florida Research Foundation, Incorporated, Gainesville, FL (US)

(72) Inventors: Patrick G. Traynor, Gainesville, FL (US); Kevin S. Warren, Gainesville, FL (US); Kevin Butler, Gainesville, FL (US); Seth Layton, Gainesville, FL (US); Daniel Olszewski, Gainesville, FL (US); Carrie Gates, Livermore, CA (US)

(21) Appl. No.: 18/305,971

(22) Filed: Apr. 24, 2023

Related U.S. Application Data
(60) Provisional application No. 63/335,012, filed on Apr. 26, 2022.

(51) Int. Cl. G10L 17/06; G10L 17/02

(52) U.S. Cl. CPC G10L 17/06; G10L 17/02

(57) ABSTRACT

Various embodiments of the present disclosure provide for detecting audio deepfakes through acoustic prosodic modeling. In one example, an embodiment provides for extracting one or more prosodic features from an audio sample and classifying the audio sample as a deepfake audio sample or an organic audio sample by applying a machine learning model to the one or more prosodic features. The one or more prosodic features can be indicative of one or more prosodic characteristics associated with human speech. Additionally, the machine learning model can be configured as a classification-based detector for audio deepfakes.

### CROSS-REFERENCE TO RELATED APPLICATIONS

This application claims the benefit of U.S. Provisional Patent Application No. 63/335,012, titled “DETECTING AUDIO DEEPFAKES THROUGH ACOUSTIC PROSODIC MODELING,” and filed on Apr. 26, 2022, which is incorporated herein by reference in its entirety.

### GOVERNMENT SUPPORT

This invention was made with government support under N00014-21-1-2658 awarded by the US NAVY OFFICE OF NAVAL RESEARCH. The government has certain rights in the invention.

### TECHNICAL FIELD

The present application relates to the technical field of audio processing, computer security, electronic privacy, and/or machine learning. In particular, the invention relates to performing audio processing and/or machine learning modeling to distinguish between organic audio produced based on a human's voice and synthetic “deepfake” audio produced digitally.

### BACKGROUND

Recent advances in voice synthesis and voice manipulation techniques have made generation of “human-sounding” but “never human-spoken” synthetic audio possible. Such technical advances can be employed for various applications such as, for example, for providing patients with vocal loss the ability to speak, for creating digital avatars capable of accomplishing certain types of tasks such as making reservation to a restaurant, etc. However, these technical advances also have potential for misuse, such as, for example, when synthetic audio mimicking a voice of a user is generated without consent by the user. Unauthorized synthetic audio such as, for example, synthetic voices are known as “audio deepfakes.”

### SUMMARY

In general, embodiments of the present invention provide methods, apparatus, systems, computing devices, computing entities, and/or the like for detecting audio deepfakes through acoustic prosodic modeling. The details of some embodiments of the subject matter described in this specification are set forth in the accompanying drawings and the description below. Other features, aspects, and advantages of the subject matter will become apparent from the description, the drawings, and the claims.

In an embodiment, a method for detecting audio deepfakes through acoustic prosodic modeling is provided. The method provides for extracting one or more prosodic features from an audio sample. In one or more embodiments, the one or more prosodic features are indicative of one or more prosodic characteristics associated with human speech. The method also provides for classifying the audio sample as a deepfake audio sample or an organic audio sample by applying a machine learning model to the one or more prosodic features. In one or more embodiments, the machine learning model is configured as a classification-based detector for audio deepfakes.

In another embodiment, an apparatus for detecting audio deepfakes through acoustic prosodic modeling is provided. The apparatus comprises at least one processor and at least one memory including program code. The at least one memory and the program code is configured to, with the at least one processor, cause the apparatus to extract one or more prosodic features from an audio sample and/or classify the audio sample as a deepfake audio sample or an organic audio sample by applying a machine learning model to the one or more prosodic features. In one or more embodiments, the one or more prosodic features are indicative of one or more prosodic characteristics associated with human speech. In one or more embodiments, the machine learning model is configured as a classification-based detector for audio deepfakes.

In yet another embodiment, a non-transitory computer storage medium comprising instructions for detecting audio deepfakes through acoustic prosodic modeling is provided. The instructions are configured to cause one or more processors to at least perform operations configured to extract one or more prosodic features from an audio sample and/or classify the audio sample as a deepfake audio sample or an organic audio sample by applying a machine learning model to the one or more prosodic features. In one or more embodiments, the one or more prosodic features are indicative of one or more prosodic characteristics associated with human speech. In one or more embodiments, the machine learning model is configured as a classification-based detector for audio deepfakes.

In another embodiment, a method for training a machine learning model for detecting audio deepfakes. The method provides for extracting one or more prosodic features from one or more audio samples, the one or more prosodic features indicative of one or more prosodic characteristics associated with human speech. The method also provides for training a machine learning model as a classification-based detector for audio deepfakes based on the one or more prosodic features extracted from the one or more audio samples.

In yet another embodiment, an apparatus for training a machine learning model for detecting audio deepfakes is provided. The apparatus comprises at least one processor and at least one memory including program code. The at least one memory and the program code is configured to, with the at least one processor, cause the apparatus to extract one or more prosodic features from one or more audio samples, the one or more prosodic features indicative of one or more prosodic characteristics associated with human speech. The at least one memory and the program code is also configured to, with the at least one processor, cause the apparatus to train a machine learning model as a classification-based detector for audio deepfakes based on the one or more prosodic features extracted from the one or more audio samples.

In yet another embodiment, a non-transitory computer storage medium comprising instructions for training a machine learning model for detecting audio deepfakes is provided. The instructions are configured to cause one or more processors to at least perform operations configured to extract one or more prosodic features from one or more audio samples, the one or more prosodic features indicative of one or more prosodic characteristics associated with human speech. The instructions are also configured to cause one or more processors to at least perform operations configured to train a machine learning model as a classification-based detector for audio deepfakes based on the one or more prosodic features extracted from the one or more audio samples.

### BRIEF DESCRIPTION OF THE DRAWINGS

Reference will now be made to the accompanying drawings, which are not necessarily drawn to scale, and wherein:

FIG. 1 illustrates a system for detecting audio deepfakes through acoustic prosodic modeling, according to one or more embodiments of the present disclosure;

FIG. 2 illustrates an example model architecture, according to one or more embodiments of the present disclosure;

FIG. 3 illustrates an exemplary framework for producing an audio deepfake, according to one or more embodiments of the present disclosure;

FIG. 4 illustrates an example spectrogram associated with an organic audio sample and an example spectrogram associated with a deepfake audio sample, according to one or more embodiments of the present disclosure;

FIG. 5 illustrates accuracy and improved performance of a model disclosed herein for correctly identifying deepfake attacks of different types, according to one or more embodiments of the present disclosure;

FIG. 6 illustrates distribution of peaking intonation and dipping intonation of organic audio samples and deepfake audio samples, according to one or more embodiments of the present disclosure;

FIG. 7 is a flowchart of a method for detecting audio deepfakes through acoustic prosodic modeling according to one or more embodiments of the present disclosure;

FIG. 8 is a flowchart of a method for training a machine learning model for detecting audio deepfakes according to one or more embodiments of the present disclosure; and

FIG. 9 illustrates a schematic of a computing entity that may be used in conjunction with one or more embodiments of the present disclosure.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

Recent advances in voice synthesis and voice manipulation techniques have made generation of “human-sounding” but “never human-spoken” audio possible. Such technical advances can be employed for various applications such as, for example, for providing patients with vocal loss the ability to speak, for creating digital avatars capable of accomplishing certain types of tasks such as making reservation to a restaurant, etc. However, these technical advances also have potential for misuse, such as, for example, when synthetic audio mimicking a voice of a user is generated without consent by the user. Unauthorized synthetic audio such as, for example, synthetic voices are known as “audio deepfakes.”

Audio deepfakes are a digitally produced speech sample (e.g., a synthesized speech sample) that is intended to sound like a specific individual. Currently, audio deepfakes are often produced via the use of machine learning algorithms. Additionally, audio deepfakes are a digitally produced (e.g., synthesized) speech sample that is intended to sound like a specific individual. While there are numerous audio deepfake machine learning algorithms in existence, generation of audio deepfakes generally involves an encoder, a synthesizer, and/or a vocoder. The encoder generally learns the unique representation of the speaker's voice, known as the speaker embedding. These can be learned using a model architecture similar to that of speaker verification systems. The speaker embedding can be derived from a short utterance using the target speaker's voice. The accuracy of the speaker embedding can be increased by giving the encoder more utterances. The output embedding from the encoder can be provided as an input into the synthesizer. The synthesizer can generate a spectrogram such as, for example, a Mel spectrogram from a given text and the speaker embedding. A Mel spectrogram is a spectrogram that comprises frequencies scaled using the Mel scale, which is designed to model audio perception of the human ear.

Some synthesizers are also able to produce spectrograms solely from a sequence of characters or phonemes. The vocoder can convert the Mel spectrogram to retrieve the corresponding audio waveform. This newly generated audio waveform will ideally sound like a target individual uttering a specific sentence. A commonly used vocoder model employs a deep convolutional neural network generates a waveform based on surrounding contextual information.

To provide further context, phonemes are the fundamental building blocks of speech. Each unique phoneme sound is a result of different configurations of the vocal tract components of a human. Phonemes that comprise the English language are categorized into vowels, fricatives, stops, affricates, nasals, glides and diphthongs. Their pronunciation is dependent upon the configuration of the various vocal tract components and the air flow through those vocal tract components. Vowels (e.g., “/I/” in ship) are created using different arrangements of the tongue and jaw, which result in resonance chambers within the vocal tract. For a given vowel, these chambers produce frequencies known as formants whose relationship determines the actual sound. Vowels are the most commonly used phoneme type in the English language, making up approximately 38% of all phonemes. Fricatives (e.g., “/s/” in sun) are generated by turbulent flow caused by a constriction in the airway, while stops (e.g., “/g/” in gate) are created by briefly halting and then quickly releasing the air flow in the vocal tract. Affricatives (e.g., “/t∫/” in church) are a concatenation of a fricative with a stop. Nasals (e.g., “/n/” in nice) are created by forcing air through the nasal cavity and tend to be at a lower amplitude than the other phonemes. Glides (e.g., “/l/” in lie) act as a transition between different phonemes and diphthongs (e.g., “/eI/” in wait) refer to the vowel sound that comes from the lips and tongue transitioning between two different vowel positions.

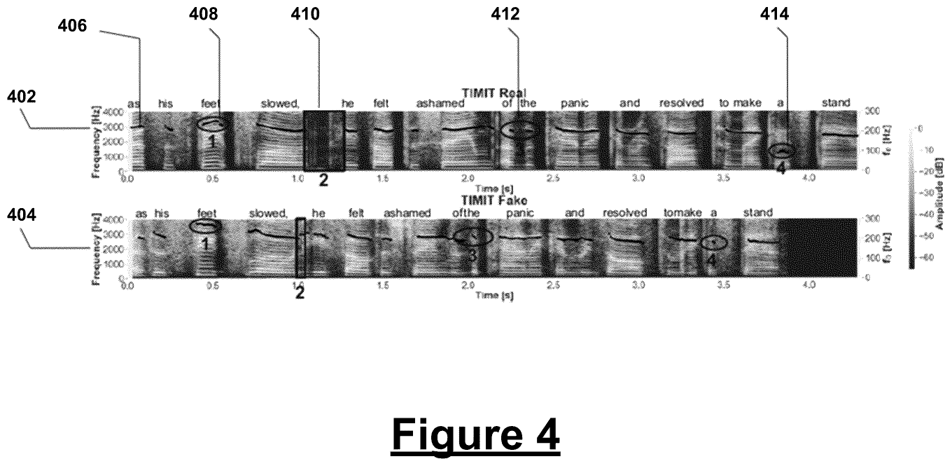

Accordingly, human audio production is the result of interactions between different components of the human anatomy. The lungs, larynx (i.e., the vocal chords), and the articulators (e.g., the tongue, cheeks, lips) work in conjunction to produce sound. The lungs force air through the vocal chords, inducing an acoustic resonance, which contains the fundamental (lowest) frequency of a speaker's voice. The resonating air then moves through the vocal cords and into the vocal tract. Here, different configurations of the articulators are used to shape the air in order to produce the unique sounds of each phoneme. As an example, to generate audible speech, a person moves air from the lungs to the mouth while passing through various components of the vocal tract. For example, the words “who” (phonetically spelled “/hu/”) and “has” (phonetically spelled “/hæ/”) have substantially different mouth positions during the pronunciation of each vowel phoneme (i.e., “/u/” in “who” and “/æ/” in “has”). FIG. 4 illustrates how some components of the vocal tract are arranged during the pronunciation of the vowel phonemes for each word mentioned above. During the pronunciation of the phoneme “/u/” in “who” the tongue compresses to the back of the mouth (i.e., away from the teeth) (A) at the same time the lower jaw is held predominately closed. The closed jaw position lifts the tongue so that it is closer to the roof of the mouth (B). Both of these movements create a specific pathway through which the air must flow as it leaves the mouth. Conversely, the vowel phoneme “/æ/” in “has” elongates the tongue into a more forward position (A) while the lower jaw distends, causing there to be more space between the tongue and the roof of the mouth. This tongue position results in a different path for the air to flow through, and thus creates a different sound. In addition to tongue and jaw movements, the position of the lips also differs for both phonemes. For “/u/”, the lips round to create a smaller more circular opening (C). Alternatively, “æ/” has the lips unrounded, leaving a larger, more elliptical opening. Just as the tongue and jaw position, the shape of the lips during speech impacts the sound created.

Another component that affects the sounds of phonemes is the other phonemes that are adjacent to it. For example, take the words “ball” (phonetically spelled “/b [symbol] l/’”) and “thought” (phonetically spelled “/θ [symbol] t/”). Both words contain the phoneme “/ [symbol] /,” however the “/ [symbol] /” in “thought” is effected by the adjacent phonemes differently than how “/ [symbol] /” in “ball” is. In particular “thought” ends with the plosive “/t/” which requires a break in airflow, thus causing the speaker to abruptly end the “/ [symbol] /” phoneme. In contrast, the “/ [symbol] /” in “ball” is followed by the lateral approximant “/l/,” which does not require a break in airflow, leading the speaker to gradually transition between the two phonemes.

While audio deepfake quality has substantially improved in recent years, audio deepfakes remain imperfect as compared to organic audio produced based on a human's voice. As such, technical advances related to detecting audio deepfakes have been developed using bi-spectral analysis (e.g., inconsistencies in the higher order correlations in audio) and/or by employing machine learning models trained as discriminators. However, audio deepfakes detection techniques and/or audio deepfake machine learning models are generally dependent on specific, previously observed generation techniques. For example, audio deepfakes detection techniques and/or audio deepfake machine learning models generally exploit low-level flaws (e.g., unusual spectral correlations, abnormal noise level estimations, and unique cepstral patterns, etc.) related to synthetic audio and/or artifacts of deepfake generation techniques to identify synthetic audio. However, synthetic voices (e.g., audio deepfakes) are increasingly indifferentiable from organic human speech, often being indistinguishable from organic human speech by authentication systems and human listeners. For example, with recent advancements related to audio deepfakes, low-level flaws are often removed from an audio deepfake. As such, improved audio deepfakes detection techniques and/or improved audio deepfake machine learning models are desirable to more accurately identify a voice audio source as a human voice or a synthetic voice (e.g., a machine-generated voice).

To address these and/or other issues, various embodiments described herein relate to detecting audio deepfakes through acoustic prosodic modeling. For example, improved audio deepfakes detection techniques and/or improved audio deepfake machine learning models that employ prosody features associated with audio samples to distinguish between organic audio and deepfake audio can be provided. Prosody features relate to high-level linguistic features of human speech such as, for example, pitch, pitch variance, pitch rate of change, pitch acceleration, intonation (e.g., peaking intonation and/or dipping intonation), vocal jitter, fundamental frequency (F0), vocal shimmer, rhythm, stress, harmonic to noise ratio (HNR), one or more metrics based on vocal range, and/or one or more other prosody features related to human speech.

In one or more embodiments, a classification-based detector for detecting audio deepfakes using one or more prosody features is provided. In various embodiments, the classification-based detector can employ prosody features to provide insights related to a speaker's emotions (e.g., the difference between genuine and sarcastic expressions “That was the best thing I have ever eaten”). The classification-based detector can additionally or alternatively employ prosody features to remove ambiguity related to audio (e.g., the difference between “I never promised to pay him” depending on whether emphasis lands on the word “I”, “never”, “promised”, or “pay”). In certain embodiments, the classification-based detector can be a multi-layer perceptron-based classifier that is trained based on one or more prosodic features mentioned above. By employing prosodic analysis for detecting audio deepfakes as disclosed herein, audio deepfake detection for distinguishing between a human voice or a synthetic voice (e.g., a machine-generated voice) can be provided with improved accuracy as compared to audio deepfake detection techniques that employ bi-spectral analysis and/or machine learning models trained as discriminators.

### Exemplary Data Pipeline for Detecting Audio Deepfakes Through Acoustic Prosodic Modeling

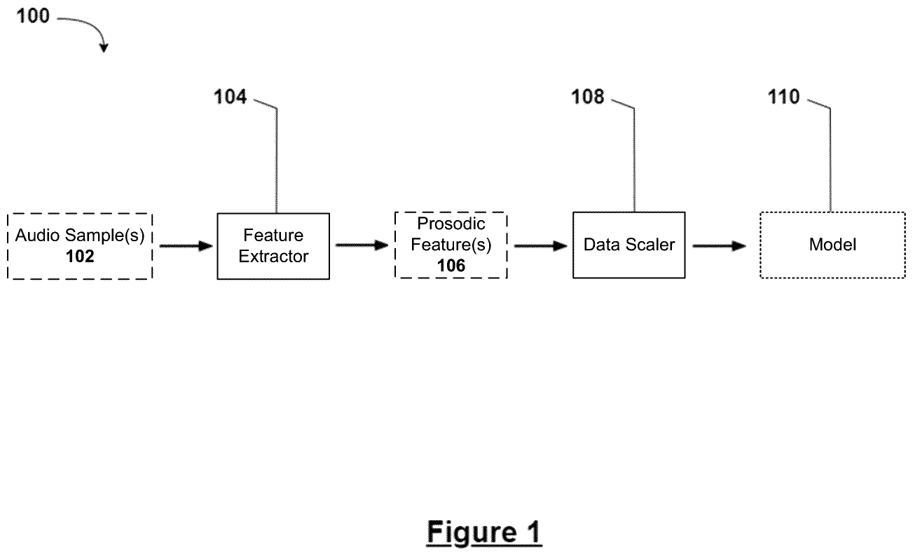

According to various embodiments, a data pipeline for detecting audio deepfakes through acoustic prosodic modeling is provided. FIG. 1 illustrates a system 100 for detecting audio deepfakes through acoustic prosodic modeling according to one or more embodiments of the present disclosure. In various embodiments, the system 100 corresponds to a data pipeline that processes prosodic features of human speech samples and provides the processed prosodic features to a machine learning model trained to classify deepfake audio. The system 100 includes a feature extractor 104, data scaler 108, and/or a model 110. In one or more embodiments, the feature extractor 104 receives one or more audio samples 102. In certain embodiments, the one or more audio samples 102 can be one or more speech samples associated with human speech. Additionally, the one or more audio samples 102 can correspond to a potential audio deepfake or organically generated audio.

The feature extractor 104 can process the one or more audio samples 102 to determine one or more prosodic features 106 associated with the one or more audio samples 102. The one or more prosodic features 106 can be configured as a feature set F for the model 110. Additionally, the one or more prosodic features 106 can include one or more pitch features, one or more pitch variance features, one or more pitch rate of change features, one or more pitch acceleration features, one or more intonation features (e.g., one or more peaking intonation features and/or one or more dipping intonation features), one or more vocal jitter features, one or more fundamental frequency features, one or more vocal shimmer features, one or more rhythm features, one or more stress features, one or more HNR features, one or more metrics features related to vocal range, and/or one or more other prosody features related to the one or more audio samples 102.

In an embodiment, at least a portion of the one or more prosodic features 106 can be measured features associated with the one or more audio samples 102. For example, the feature extractor 104 can measure one or more prosodic features using one or more prosodic analysis techniques and/or one or more statistical analysis techniques associated with synthetic voice detection. In certain embodiments, the feature extractor 104 can measure one or more prosodic features using one or more acoustic analysis techniques that derive prosodic features from a time-based F₀ sequence. Additionally, in various embodiments, at least a portion of the one or more prosodic features 106 can correspond to parameters employed in applied linguistics to diagnose speech pathologies, rehabilitate voices, and/or to improve public speaking skills.

In one or more embodiments, one or more of the prosodic features measured by the feature extractor 104 can include a mean and/or a standard deviation of the fundamental frequency associated with the one or more audio samples 102, a pitch range associated with the one or more audio samples 102, a set of different jitter values associated with the one or more audio samples 102, a set of unique shimmer values associated with the one or more audio samples 102, and/or an HNR associated with the one or more audio samples 102.

Prosodic acoustic analysis can employ a set of prosody features to objectively describe human voice. While prosody features can include fundamental frequency, pitch, jitter, shimmer, and the HNR, prosody features can additionally be associated with additional attributes (e.g., intonation) to digitally capture complexity of human speech and/or to assist with processing by the feature extractor 104. Fundamental frequency and pitch are the basic features that describe human speech. Frequency is the number of times a sound wave repeats during a given time period and fundamental frequency is the lowest frequency of a voice signal. Similarly, pitch is defined as the brain's perception of the fundamental frequency. The difference between fundamental frequency and pitch can be determined based on phantom fundamentals. Additionally, voiced speech comes from a fluctuant organic source, making it quasi-periodic. As such, voiced speech comprises measurable differences in the oscillation of audio signals. Jitter is the frequency variation between two cycles (e.g., period length) and shimmer measures the amplitude variation of a sound wave. Jitter comes from lapses in control of our vocal cord vibrations and is commonly seen in high number with people who have speech pathologies. The jitter levels in a person's voice are a representation of how “hoarse” their voice sounds. Shimmer, however, corresponds to the presence of breathiness or noise emissions in our speech. Both jitter and shimmer capture the subtle inconsistencies that are present in human speech

Harmonic to noise ratio is the ratio of periodic and non-periodic components within a segment of voiced speech. The HNR of a speech sample is commonly referred to as harmonicity and measures the efficiency of a person's speech. With respect to the prosody, HNR denotes the texture (e.g., softness or roughness) of a person's sound. The combination of jitter, shimmer, and HNR can quantify an individual's voice quality. Intonation is the rise and fall of a person's voice (e.g., melodic patterns). One of the ways speakers communicate emotional information in speech is expressiveness, which is directly conveyed through intonation. Varying tones help to give meaning to an utterance, allowing a person to stress certain parts of speech and/or to express a desired emotion. A shift from a rising tone to a falling tone corresponds to peaking intonation and the shift from falling tone to a rising tone corresponds to dipping intonation.

The following is an equation (1) that can be employed by the feature extractor 104 to determine a prosodic feature associated with jitter local absolute (jitt_{abs}) that corresponds to an average absolute difference between consecutive periods in seconds:

$${jitt}_{abs} = \frac{1}{N - 1} {\sum }_{i = 1}^{N - 1} \vert {T}_{i} - {T}_{i + 1} \vert \qquad ( 1 )$$

where Ti is period length of an audio sample, Aᵢ is amplitude of an audio sample, and N is a number of intervals for an audio sample.

The following is an equation (2) that can be additionally or alternatively employed by the feature extractor 104 to determine a prosodic feature associated with jitter local (jitt) that corresponds to an average absolute difference between consecutive periods divided by the average period:

$$jitt = \frac{{jitt}_{abs}}{\frac{1}{N} {\sum }_{i = 1}^{N} {T}_{i}} \times 100 \qquad ( 2 )$$

The following is an equation (3) that can be additionally or alternatively employed by the feature extractor 104 to determine a prosodic feature associated with jitter ppq5 (jitt_{ppq5}) that corresponds to a five-point period perturbation quotient, the average absolute difference between a period and the average of the period and four closest neighbors, divided by the average period:

$${jitt}_{ppq 5} = \frac{\frac{1}{N - 4} {\sum }_{i = 3}^{N - 2} \vert {T}_{i} - ( \frac{1}{5} {\sum }_{n = i - 2}^{i + 2} {T}_{n} ) \vert}{\frac{1}{N} {\sum }_{i = 1}^{N} {T}_{i}} \times 100 \qquad ( 3 )$$

The following is an equation (4) that can be additionally or alternatively employed by the feature extractor 104 to determine a prosodic feature associated with jitter rap (jitt_{ddp}) that corresponds to relative average perturbation, the average absolute difference between a period and the average of the period and two neighbors, divided by the average period:

$${jitt}_{rap} = \frac{\frac{1}{N - 2} {\sum }_{i = 2}^{N - 1} \vert {T}_{i} - ( \frac{1}{3} {\sum }_{n = i - 1}^{i + 3} {T}_{n} ) \vert}{\frac{1}{N} {\sum }_{i = 1}^{N} {T}_{i}} \times 100 \qquad ( 4 )$$

The following is an equation (5) that can be additionally or alternatively employed by the feature extractor 104 to determine a prosodic feature associated with jitter ddp (jitt_{ddp}) that corresponds to average absolute difference between consecutive differences between consecutive periods, divided by the average period:

jitt_{ddp}=3×jittᵣₐₚ (5)

The prosodic feature associated with jitter ddp can be equal to three times the value of the prosodic feature associated with jitter rap.

The following is an equation (6) that can be additionally or alternatively employed by the feature extractor 104 to determine a prosodic feature associated with shimmer local (shim) that corresponds to the average absolute difference between the amplitudes of consecutive periods, divided by the average amplitude:

$$shim = \frac{\frac{1}{N - 1} {\sum }_{i = 1}^{N - 1} \vert {A}_{i} - {A}_{i + 1} \vert}{\frac{1}{N} {\sum }_{i = 1}^{N} {A}_{i}} \times 100 \qquad ( 6 )$$

The following is an equation (7) that can be additionally or alternatively employed by the feature extractor 104 to determine a prosodic feature associated with shimmer local dB (shim_{dB}) that corresponds to the average absolute base-10 logarithm of the difference between the amplitudes of consecutive periods, multiplied by 20:

$${shim}_{dB} = \frac{1}{N - 1} {\sum }_{i = 1}^{N - 1} \vert 20 \times log ( \frac{{A}_{i + 1}}{{A}_{i}} ) \vert \qquad ( 7 )$$

The following is an equation (8) that can be additionally or alternatively employed by the feature extractor 104 to determine a prosodic feature associated with shimmer apq5 (shim_{apq5}) that corresponds to the five-point amplitude perturbation quotient, the average absolute difference between the amplitude of a period and the average of the amplitudes of the period and four closest neighbors, divided by the average amplitude:

$${shim}_{apq 3} = \frac{\frac{1}{N - 1} {\sum }_{i = 2}^{N - 2} \vert {A}_{i} ( \frac{1}{5} ( {\sum }_{n = i - 2}^{i + 2} {A}_{n} ) \vert}{\frac{1}{N} {\sum }_{i = 2}^{N} {A}_{i}} \times 100 \qquad ( 8 )$$

The following is an equation (9) that can be additionally or alternatively employed by the feature extractor 104 to determine a prosodic feature associated with shimmer apq3 (shim_{apq3}) that corresponds to the three-point amplitude perturbation quotient, the average absolute difference between the amplitude of a period and the average of the amplitudes of neighbors, divided by the average amplitude:

$${shim}_{apq 3} = \frac{\frac{1}{N - 1} {\sum }_{i = 1}^{N - 1} \vert {A}_{i} - ( \frac{1}{3} {\sum }_{n = i - 1}^{i + 1} {A}_{n} ) \vert}{\frac{1}{N} {\sum }_{i = 1}^{N} {A}_{i}} \times 100 \qquad ( 9 )$$

The following is an equation (10) that can be additionally or alternatively employed by the feature extractor 104 to determine a prosodic feature associated with shimmer dda (shim_{dda}) that corresponds to the average absolute difference between consecutive differences between the amplitudes of consecutive periods:

shim_{dda}=3×shim_{apq3} (10)

The prosodic feature associated with shimmer dda can be equal to three times the value of the prosodic feature associated with shimmer apq3.

The following is an equation (11) that can be additionally or alternatively employed by the feature extractor 104 to determine a prosodic feature associated with a harmonic to noise ratio (HRN) that represents the degree of acoustic periodicity expressed in dB:

$$HNR = 10 \times {log}_{10} \frac{{sig}_{per}}{{sig}_{noise}} \qquad ( 11 )$$

where sigₚₑᵣ is the proportion of the signal that is periodic and sig noise is the proportion of the signal that is noise.

Additionally or alternatively, at least a portion of the one or more prosodic features 106 can be derived features associated with the one or more audio samples 102. For example, the feature extractor 104 can derive vocal range, pitch rate of change, pitch acceleration, and/or intonation based on the fundamental frequency sequence of the one or more audio samples 102. In various embodiments, the feature extractor 104 can store a fundamental frequency sequence for each audio sample from the one or more audio samples 102. The feature extractor 104 can employ the fundamental frequency sequence to calculate the derived features included in the one or more prosodic features 106. A fundamental frequency sequence can be a series of F0 values sampled with respect to time.

In various embodiments, features calculated by the feature extractor 104 using the individual F0 values can include a pitch range value and/or a maximum fundamental frequency value for respective audio samples from the one or more audio samples 102. In various embodiments, the fundamental frequency sequence can be uniformly sampled on an even time step. Using the uniform time step and the individual points in the fundamental frequency sequence, the feature extractor 104 can derive a second-order approximation of the first and second derivatives to determine pitch rate of change and/or the pitch acceleration associated with the one or more audio samples 102.

In an embodiment, the feature extractor 104 can employ the following second-order centered difference approximation of the first derivative to determine a pitch rate of change feature and/or a pitch acceleration feature associated with the one or more audio samples 102:

$${f}^{′} ( t ) = \frac{f ( t + Δ t ) - f ( t - Δ t )}{2 Δ t} .$$

where Δt represents a time step for time t. Additionally or alternatively, the feature extractor 104 can employ the following second-order centered difference approximation of the second derivative to determine an acceleration feature associated with the one or more audio samples 102:

$${f}^{″} ( t ) = \frac{f ( t + Δ t ) - 2 f ( t ) + f ( t - Δ t )}{Δ {t}^{2}} .$$

In various embodiments, the feature extractor 104 can employ the derivatives to determine a number of inflection points (e.g., sign changes in f′(t)) in the one or more audio samples 102, which measures the total amount of peaking intonation and/or dipping intonation. In various embodiments, the feature extractor 104 can determine a maximum z-score for a fundamental frequency (e.g., the F0 value that falls farthest from the mean fundamental frequency) and/or the proportion of the data that falls outside the 90% confidence interval (e.g., the proportion of standard deviation calculated outliers).

In various embodiments, the one or more prosodic features 106 can undergo data scaling by the data scaler 108. In various embodiments, the data scaler 108 can scale the one or more prosodic features 106 by standardizing the data with basic scaling. For example, the data scaler 108 can perform data scaling with respect to the one or more prosodic features 106 in order to ensure that no particular prosodic feature influences the model 110 more than another strictly due to a corresponding magnitude.

In various embodiments, the data scaler 108 can perform data scaling with respect to the one or more prosodic features 106 by determining the average and/or standard deviation of each prosodic feature from the one or more prosodic features 106, subtracting the average, and dividing by the standard deviation. For example, the data scaler 108 can employ the following equation for the data scaling with respect to the one or more prosodic features 106:

$${x}_{scaled} = \frac{x - μ}{σ} .$$

where x corresponds to a feature column, μ corresponds to the average of the feature column, and σ corresponds to the standard deviation of the feature column. A feature column can include one or more features from the one or more prosodic features 106.

In various embodiments, the one or more prosodic features 106 (e.g., the scaled version of the one or more prosodic features 106) can be employed as a training set to generate the model 110. The model 110 can be a machine learning model configured to detecting audio deepfakes. In various embodiments, the one or more prosodic features 106 (e.g., the scaled version of the one or more prosodic features 106) can be employed as input to a trained version of the model 110 configured to detect audio deepfakes. For example, the trained version of the model 110 can be configured to determine whether the one or more audio samples are audio deepfakes or organic audio sample associated with human speech.

In an embodiment, the model 110 can be a classifier model. For example, the model 110 can be a classification-based detector. In certain embodiments, the model 110 can be a neural network model or another type of deep learning model. In certain embodiments, the model 110 can be a multilayer perceptron (MLP) such as, for example, a multi-layer perceptron-based classifier. In certain embodiments, the model 110 can be a logistic regression model. In certain embodiments, the model 110 can be a k-nearest neighbors (kNN) model. In certain embodiments, the model 110 can be a random forest classifier (RFC) model. In certain embodiments, the model 110 can be a support vector machine (SVM) model. In certain embodiments, the model 110 can be a deep neural network (DNN) model. However, it is to be appreciated that, in certain embodiments, the model 110 can be a different type of machine learning model configured for classification-based detection between audio deepfake samples and organic audio samples associated with human speech.

In certain embodiments, the model 110 can include a set of hidden layers configured for classification-based detection between audio deepfake samples and organic audio samples associated with human speech. In certain embodiments, a grid search can be employed to determine an optimal number of hidden layers for the model 110 during training of the model 110. In certain embodiments, the model 110 can include one or more hidden layers. In certain embodiments, respective hidden layers of the model 110 can additionally employ a Rectified Linear Unit (ReLU) configured as an activation function and/or a dropout layer configured with a defined probability. In certain embodiments, respective hidden layers of the model 110 can comprise a dense layer with a certain degree of constraint on respective weights.

### Exemplary Model Architecture

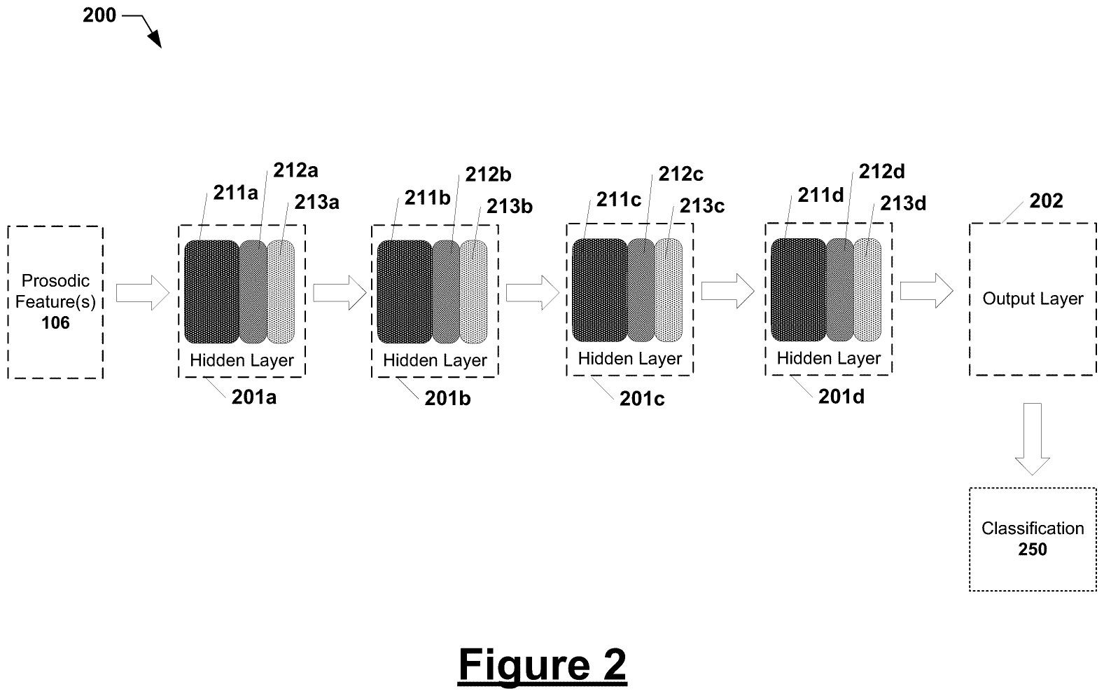

FIG. 2 illustrates an example model architecture 200 accordingly to according to one or more embodiments of the present disclosure. In one or more embodiments, the model architecture 200 can correspond to a model architecture for the model 110. In one or more embodiments, the model architecture 200 can be configured as an MLP model. The model architecture 200 can be configured as a defender model to classify audio samples of human speech as deepfake audio or organically generated audio. For example, the model architecture 200 can classify the one or more audio samples 102 as deepfake audio or organically generated audio. However, in an alternate embodiment, the model architecture 200 can be configured as an adversary model to generate an audio sample representing, for example, a human being uttering a specific phrase or set of phrases.

In the example embodiment illustrated in FIG. 2, the model architecture 200 includes a first hidden layer 201a, a second hidden layer 201b, a third hidden layer 201c, a fourth hidden layer 201d, and/or an output layer 202. In one or more embodiments, the one or more prosodic features 106 are provided as input to the first hidden layer 201a. The one or more prosodic features 106 provided as input to the first hidden layer 201a can correspond to a version of the one or more audio samples 102 that have undergone processing by the feature extractor 104 and/or the data scaler 108. For example, the version of the one or more prosodic features 106 provided as input to the first hidden layer 201a can correspond to a scaled version of the one or more prosodic features 106 associated with the one or more audio samples 102. In one or more embodiments, the first hidden layer 201a, the second hidden layer 201b, the third hidden layer 201c, and the fourth hidden layer 201d can respectively apply a particular set of weights to one or more inputs related to the one or more prosodic features 106. For example, the first hidden layer 201a, the second hidden layer 201b, the third hidden layer 201c, and the fourth hidden layer 201d can respectively apply a nonlinear transformation to one or more inputs related to the one or more prosodic features 106 based a particular set of weights of the respective hidden layer.

In certain embodiments, the first hidden layer 201a can include a dense layer 211a configured with size 64 (e.g., 64 fully connected neuron processing units), the second hidden layer 201b can include a dense layer 211b configured with size 32 (e.g., 32 fully connected neuron processing units), the third hidden layer 201c can include a dense layer 211c configured with size 32 (e.g., 32 fully connected neuron processing units), and the fourth hidden layer can include a dense layer 211d configured with size 16 (e.g., 16 fully connected neuron processing units). For example, the dense layer 211a, the dense layer 211b, the dense layer 211c, and the dense layer 211d can respectively apply a particular set of weights, a particular set of biases, and/or a particular activation function to one or more portions of the one or more prosodic features 106. Additionally or alternatively, the first hidden layer 201a can include an ReLU 212a, the second hidden layer 201b can include an ReLU 212b, the third hidden layer 201c can include an ReLU 212c, and/or the fourth hidden layer 201d can include an ReLU 212d. For example, the ReLU 212a, the ReLU 212b, the ReLU 212c, and the ReLU 212d can respectively apply a particular activation function associated with a threshold for one or more portions of the one or more prosodic features 106. Additionally or alternatively, the first hidden layer 201a can include a dropout layer 213a, the second hidden layer 201b can include a dropout layer 213b, the third hidden layer 201c can include a dropout layer 213c, and/or the fourth hidden layer 201d can include a dropout layer 213d. In an example, the dropout layer 213a, the dropout layer 213b, the dropout layer 213c, and/or the dropout layer 213d can be configured with a particular probably value (e.g., P=0.25, etc.) related to a particular node of a respective hidden layer being excluded for processing of one or more portions of the one or more prosodic features 106.

The output layer 202 can provide a classification 250 for the one or more audio samples 102 based on the one or more machine learning techniques applied to the one or more prosodic features 106 via the first hidden layer 201a, the second hidden layer 201b, the third hidden layer 201c, and/or the fourth hidden layer 201d. For example, the output layer 202 can provide the classification 250 for the one or more audio samples 102 as either deepfake audio or organically generated audio. Accordingly, the classification 250 can be a deepfake audio prediction for the one or more audio samples 102. In one or more embodiments, the output layer 202 can be configured as a sigmoid output layer. For example, the output layer 202 can be configured as a sigmoid activation function configured to provide a first classification associated with a deepfake audio classification and/or a second classification associated with an organically generated audio classification for the one or more audio samples 102. However, in certain embodiments, it is to be appreciated that the output layer 202 can generate an audio sample related to a particular phrase or set of phrases input to the first hidden layer 201a, the second hidden layer 201b, the third hidden layer 201c, and/or the fourth hidden layer 201d (e.g., rather than the classification 250) to facilitate digital creation of a human being uttering the particular phrase or set of phrases. In certain embodiments, one or more weights, biases, activation function, neurons, and/or another portion of the first hidden layer 201a, the second hidden layer 201b, the third hidden layer 201c, and/or the fourth hidden layer 201d can be retrained and/or updated based on the classification 250. In certain embodiments, an alternate model for classifying the one or more audio samples can be selected and/or executed based on a predicted accuracy associated with the classification 250. In certain embodiments, visual data associated with the classification 250 can be rendered via a graphical user interface of a computing device.

### Exemplary Audio Deepfake Architecture

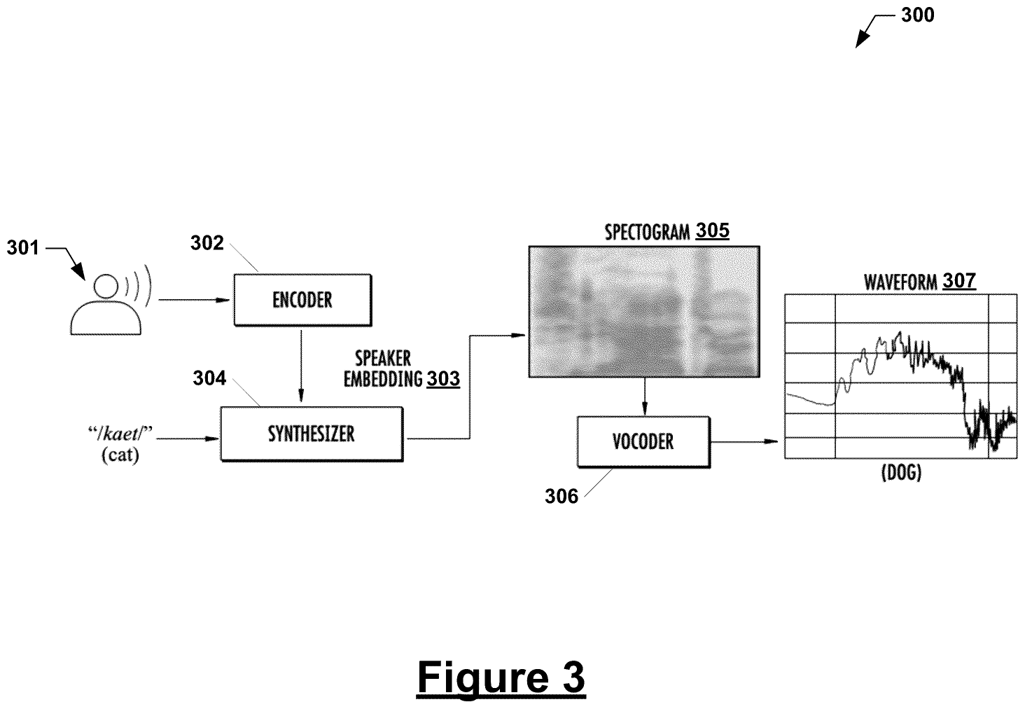

FIG. 3 illustrates an exemplary framework 300 for producing an audio deepfake according to one or more embodiments of the present disclosure. The framework 300 includes three stages: an encoder 302, a synthesizer 304, and vocoder 306.

The encoder 302 learns a unique representation of a voice of a speaker 301, known as a speaker embedding 303. In certain embodiments, these can be learned using a model architecture similar to that of a speaker verification system. The speaker embedding 303 can be derived from a short utterance using the voice of the speaker 301. The accuracy of the speaker embedding 303 can be increased by giving the encoder more utterances, with diminishing returns. The output speaker embedding 303 from the encoder 302 can then be passed as an input into the synthesizer stage 304.

The synthesizer 304 can generate a spectrogram 305 from a given text and the speaker embedding 303. The spectrogram 305 can be, for example, a Mel spectrogram. For example, the spectrogram 305 can comprise frequencies scaled using the Mel scale, which is designed to model audio perception of the human ear. Some synthesizers are also able to produce spectrograms solely from a sequence of characters or phonemes.

The vocoder 306 converts the spectrogram 305 to retrieve a corresponding waveform 307. For example, the waveform 307 can be an audio waveform associated with the spectrogram 305. This waveform 307 can be configured to sound like the speaker 301 uttering a specific sentence. In certain embodiments, the vocoder 306 can correspond to a vocoder model such as, for example, a WaveNet model, that utilizes a deep convolutional neural network to process surrounding contextual information and to generate the waveform 307. In one or more embodiments, one or more portions of the one or more audio samples 102 can correspond to one or more portions of the waveform 307.

### Exemplary Spectrograms for Audio Samples

FIG. 4 illustrates an example spectrogram 402 associated with an organic audio sample and an example spectrogram 404 associated with a deepfake audio sample, accordingly to one or more embodiments of the present disclosure. For example, the spectrogram 402 can digitally represent an organic audio sample of human speech associated with a particular sentence (e.g., “as his feet slowed, he felt ashamed of the panic and resolved to make a stand”) and the spectrogram 404 can represent a deepfake audio sample trained on the same human speech associated with the particular sentence. In various embodiments, a fundamental frequency sequence associated with a prosodic feature 106 can be a series of fundamental frequency values sampled with respect to time. These fundamental frequency values are shown in FIG. 4 as the dots that make up the black lines in the spectrograms 402 and 404. The fundamental frequency sequences of organic and synthetic speech are similar, but even for the same sentence and speaker they are not the same. The differences are illustrated in FIG. 4 with the spectrogram 404 associated with the deepfake audio sample being shorter than the spectrogram 402 associated with organic audio sample. Additionally, differences are illustrated in FIG. 4 with words such as “he” where the spectrogram 402 associated with organic audio sample comprises a dipping intonation versus the spectrogram 404 associated with the deepfake audio sample where words such as “he” comprises a peaking intonation. These distinctions demonstrate that deepfake audio samples generate pitch without perfectly mimicking the correct fundamental frequency sequence. The generation issues that are highlighted illustrate inflection changes 408, pause discrepancies 410, and combinations of inflection changes/pause discrepancies/pitch variance 412, 414.

### Exemplary Performance of Acoustic Prosodic Modeling

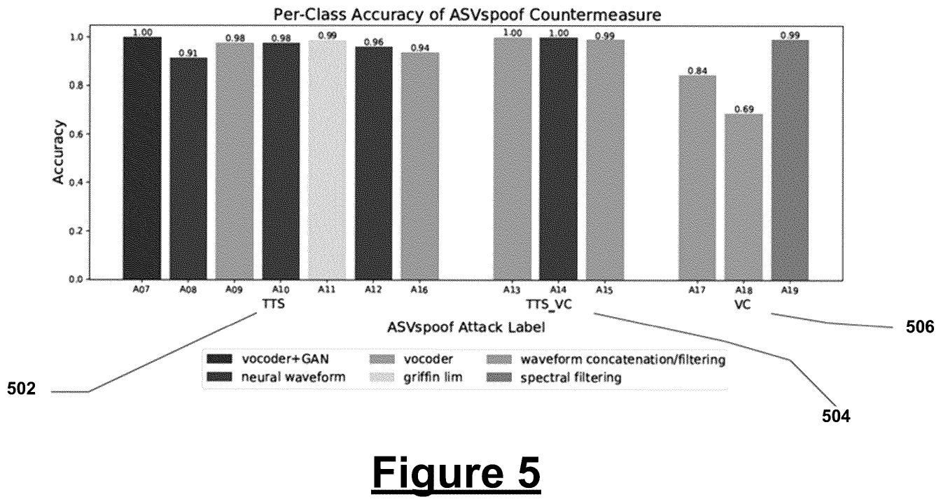

FIG. 5 illustrates accuracy and improved performance of the model 110 in correctly identifying deepfake attacks of different types according to one or more embodiments of the present disclosure. In the example embodiment illustrated in FIG. 5, the ASVspoof2019 dataset, a dataset containing at least 63,882 synthetic attack audio samples and 7,355 organic human speech samples, was employed to train the model 110. FIG. 5 can also illustrate prediction accuracy associated with the model 110 for three generation types of deepfake audio attacks: Text-to-Speech (TTS) 502, Text-to-Speech with Voice Conversion (TTS+VC) 504, and Voice Conversion (VC) 506. Each attack also was created using a specific generation method. As illustrated in FIG. 5, for the TTS 502 TTS+VC 504, and VC 506 deepfake audio attacks, the model 110 provides an accuracy of 97.5% for detecting deepfake audio in audio samples.

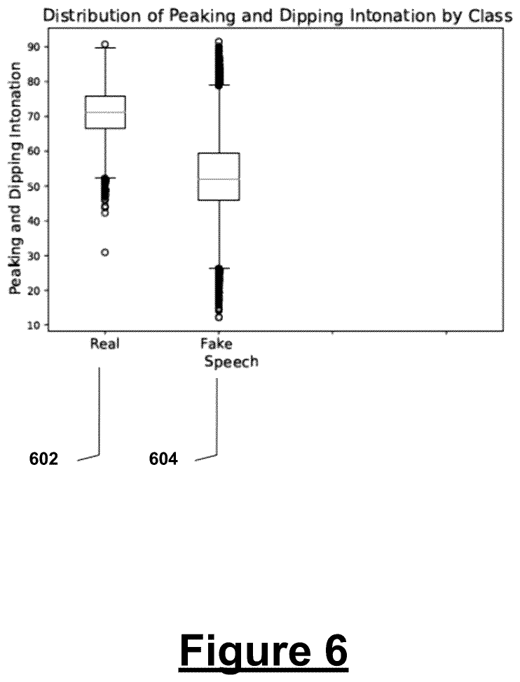

FIG. 6 illustrates the distribution of peaking intonation and dipping intonation of organic audio samples 602 and deepfake audio samples 604 according to one or more embodiments of the present disclosure. In an embodiment, the model 110 is configured to distinguish between the organic audio samples 602 and deepfake audio samples 604 using peaking intonation features and/or dipping intonation features. As illustrated in FIG. 6, there is a distinct difference between the organic audio samples 602 and the deepfake audio samples 604 based on the peaking intonation features and/or dipping intonation features classified by the model 110.

### Exemplary Methods for Detecting Audio Deepfakes Through Acoustic Prosodic Modeling

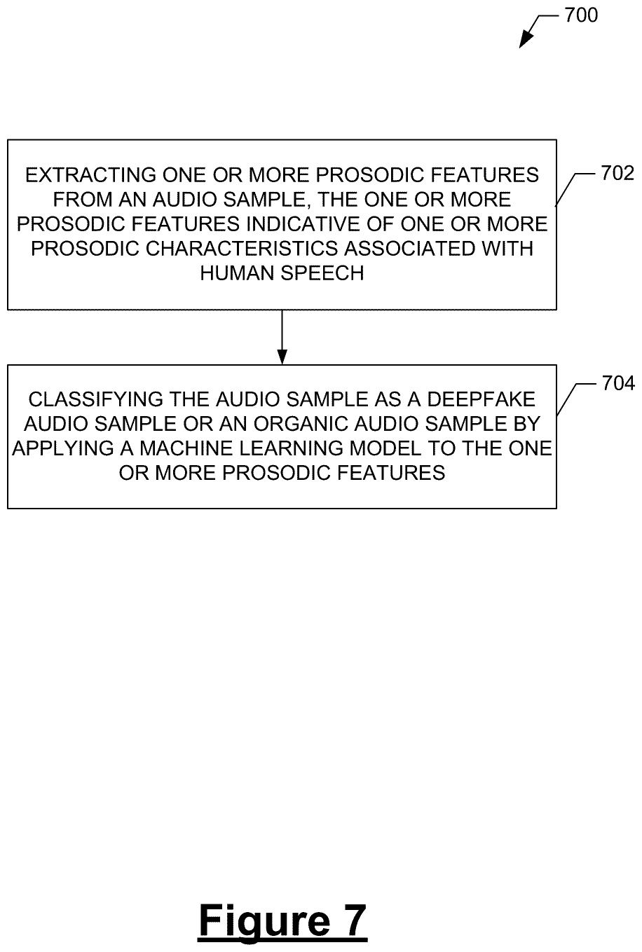

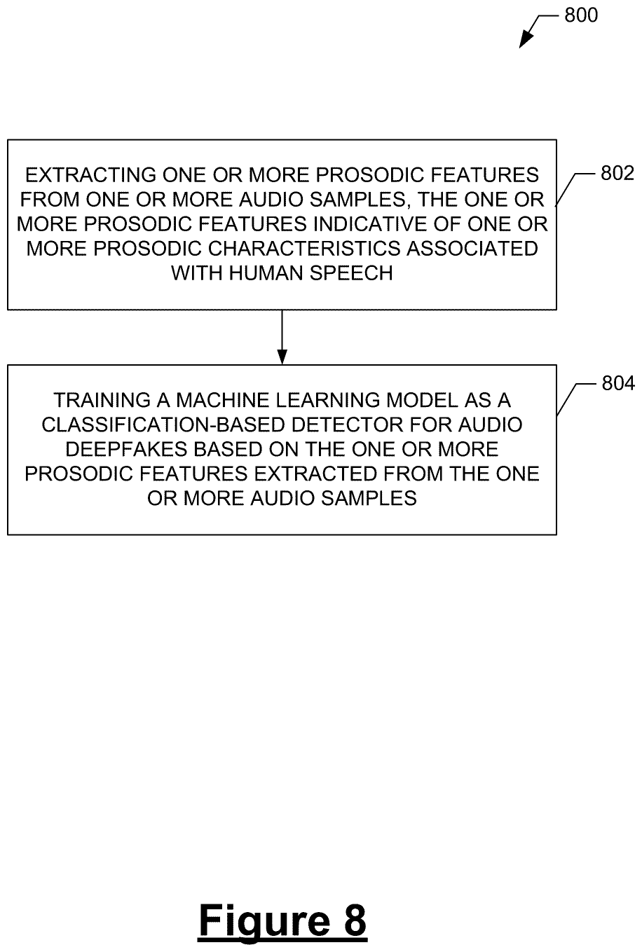

FIGS. 7-8 illustrate a flowcharts depicting methods according to example embodiments of the present disclosure. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present disclosure and executed by a processor of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions that execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems that perform the specified functions, or combinations of special purpose hardware and computer instructions.

FIG. 7 illustrates a flowchart of a method 700 for detecting audio deepfakes through acoustic prosodic modeling according to one or more embodiments of the present disclosure. According to the illustrated embodiment, the method 700 includes a step 702 for extracting one or more prosodic features from an audio sample, the one or more prosodic features indicative of one or more prosodic characteristics associated with human speech. The one or more prosodic features can be indicative of one or more prosodic characteristics associated with human speech. Additionally, the method 700 includes a step 704 for classifying the audio sample as a deepfake audio sample or an organic audio sample by applying a machine learning model to the one or more prosodic features. In one or more embodiments, the machine learning model is configured as a classification-based detector for audio deepfakes.

In certain embodiments, the classifying the audio sample comprises identifying the audio sample as the deepfake audio sample in response to the one or more prosodic features of the audio sample failing to correspond to a predefined organic audio classification measure as determined by the machine learning model.

In certain embodiments, the extracting the one or more prosodic features comprises extracting one or more pitch features, one or more intonation features, one or more jitter features, one or more fundamental frequency features, one or more shimmer features, one or more rhythm features, one or more stress features, one or more harmonic-to-noise ratio features, and/or one or more metrics features related to the one or more audio samples.

In certain embodiments, the machine learning model is a deep learning model, a neural network model, an MLP model, a kNN model, an RFC model, an SVM, a DNN model, or another type of machine learning model.

In certain embodiments, the method 500 includes scaling the one or more prosodic features for processing by the machine learning model.

In certain embodiments, the method 500 includes applying one or more hidden layers of the machine learning model to the one or more prosodic features to facilitate the classifying.

In an example embodiment, an apparatus for performing the method 700 of FIG. 7 above may include a processor configured to perform some or each of the operations (702 and/or 704) described above. The processor may, for example, be configured to perform the operations (702 and/or 704) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 702 and/or 704 may comprise, for example, the processor and/or a device or circuit for executing instructions or executing an algorithm for processing information as described above.

FIG. 8 illustrates a flowchart of a method 800 for training a machine learning model for detecting audio deepfakes according to one or more embodiments of the present disclosure. According to the illustrated embodiment, the method 800 includes a step 802 for extracting one or more prosodic features from one or more audio samples, the one or more prosodic features indicative of one or more prosodic characteristics associated with human speech. Additionally, the method 800 includes a step 804 for training a machine learning model as a classification-based detector for audio deepfakes based on the one or more prosodic features extracted from the one or more audio samples.

In certain embodiments, the extracting the one or more prosodic features comprises extracting one or more pitch features, one or more intonation features, one or more jitter features, one or more fundamental frequency features, one or more shimmer features, one or more rhythm features, one or more stress features, one or more harmonic-to-noise ratio features, and/or one or more metrics features related to the one or more audio samples.

In certain embodiments, the extracting the one or more prosodic features comprises deriving a fundamental frequency sequence for respective audio samples from the one or more audio samples. The fundamental frequency sequence can be a series of fundamental frequency values sampled with respect to time.

In certain embodiments, the one or more prosodic features are scaled for processing by the machine learning model.

In certain embodiments, the machine learning model is configured as a deep learning model, a neural network model, an MLP model, a kNN model, an RFC model, an SVM, a DNN model, or another type of machine learning model.

In certain embodiments, one or more steps (802 and/or 804) of the method 800 can be implemented in combination with one or more steps (702 and/or 704) of the method 700. For example, in certain embodiments, the trained version of the machine learning model provided by the method 800 can be employed for classifying an audio sample as a deepfake audio sample or an organic audio sample (e.g., via the step 704 of the method 700).

In an example embodiment, an apparatus for performing the method 800 of FIG. 8 above may include a processor configured to perform some or each of the operations (802 and/or 804) described above. The processor may, for example, be configured to perform the operations (802 and/or 804) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 802 and/or 804 may comprise, for example, the processor and/or a device or circuit for executing instructions or executing an algorithm for processing information as described above.

### Exemplary Technical Implementation of Various Embodiments

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described with reference to example operations, steps, processes, blocks, and/or the like. Thus, it should be understood that each operation, step, process, block, and/or the like may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

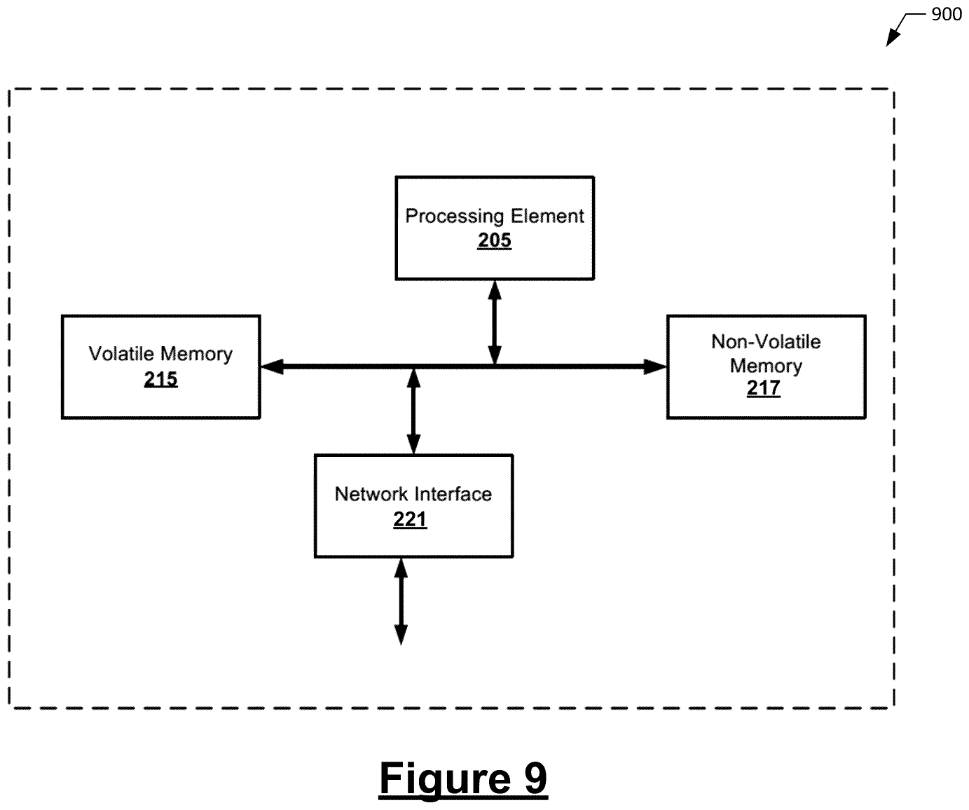

FIG. 9 provides a schematic of an exemplary apparatus 900 that may be used in accordance with various embodiments of the present disclosure. In particular, the apparatus 900 may be configured to perform various example operations described herein to provide for detecting audio deepfakes through acoustic prosodic modeling.

In general, the terms computing entity, entity, device, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

Although illustrated as a single computing entity, those of ordinary skill in the field should appreciate that the apparatus 900 shown in FIG. 9 may be embodied as a plurality of computing entities, tools, and/or the like operating collectively to perform one or more processes, methods, and/or steps. As just one non-limiting example, the apparatus 900 may comprise a plurality of individual data tools, each of which may perform specified tasks and/or processes.

Depending on the embodiment, the apparatus 900 may include one or more network and/or communications interfaces 221 for communicating with various computing entities, such as by communicating data, content, information, and/or similar terms used herein interchangeably that can be transmitted, received, operated on, processed, displayed, stored, and/or the like. Thus, in certain embodiments, the apparatus 900 may be configured to receive data from one or more data sources and/or devices as well as receive data indicative of input, for example, from a device.

The networks used for communicating may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks may have any suitable communication range associated therewith and may include, for example, global networks (e.g., the Internet), MANs, WANs, LANs, or PANs. In addition, the networks may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

Accordingly, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the apparatus 900 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), 5G New Radio (5G NR), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The apparatus 900 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

In addition, in various embodiments, the apparatus 900 includes or is in communication with one or more processing elements 205 (also referred to as processors, processing circuitry, and/or similar terms used herein interchangeably) that communicate with other elements within the apparatus 900 via a bus, for example, or network connection. As will be understood, the processing element 205 may be embodied in several different ways. For example, the processing element 205 may be embodied as one or more complex programmable logic devices (CPLDs), microprocessors, multi-core processors, coprocessing entities, application-specific instruction-set processors (ASIPs), and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware, computer program products, or a combination thereof, the processing element 205 may be capable of performing steps or operations according to embodiments of the present disclosure when configured accordingly.

In various embodiments, the apparatus 900 may include or be in communication with non-volatile media (also referred to as non-volatile storage, memory, memory storage, memory circuitry and/or similar terms used herein interchangeably). For instance, the non-volatile storage or memory may include one or more non-volatile storage or non-volatile memory media 217 such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or non-volatile memory media 217 may store files, databases, database instances, database management system entities, images, data, applications, programs, program modules, scripts, source code, object code, byte code, compiled code, interpreted code, machine code, executable instructions, and/or the like. The term database, database instance, database management system entity, and/or similar terms used herein interchangeably and in a general sense refer to a structured or unstructured collection of information/data that is stored in a computer-readable storage medium.

In particular embodiments, the non-volatile memory media 217 may also be embodied as a data storage device or devices, as a separate database server or servers, or as a combination of data storage devices and separate database servers. Further, in some embodiments, the non-volatile memory media 217 may be embodied as a distributed repository such that some of the stored information/data is stored centrally in a location within the system and other information/data is stored in one or more remote locations. Alternatively, in some embodiments, the distributed repository may be distributed over a plurality of remote storage locations only. As already discussed, various embodiments contemplated herein use data storage in which some or all the information/data required for various embodiments of the disclosure may be stored.

In various embodiments, the apparatus 900 may further include or be in communication with volatile media (also referred to as volatile storage, memory, memory storage, memory circuitry and/or similar terms used herein interchangeably). For instance, the volatile storage or memory may also include one or more volatile storage or volatile memory media 215 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like.

As will be recognized, the volatile storage or volatile memory media 215 may be used to store at least portions of the databases, database instances, database management system entities, data, images, applications, programs, program modules, scripts, source code, object code, byte code, compiled code, interpreted code, machine code, executable instructions, and/or the like being executed by, for example, the processing element 205. Thus, the databases, database instances, database management system entities, data, images, applications, programs, program modules, scripts, source code, object code, byte code, compiled code, interpreted code, machine code, executable instructions, and/or the like may be used to control certain aspects of the operation of the apparatus 900 with the assistance of the processing element 205 and operating system.

As will be appreciated, one or more of the computing entity's components may be located remotely from the other computing entity components, such as in a distributed system. Furthermore, one or more of the components may be aggregated, and additional components performing functions described herein may be included in the apparatus 900. Thus, the apparatus 900 can be adapted to accommodate a variety of needs and circumstances.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for detecting audio deepfakes through acoustic prosodic modeling, comprising:
extracting one or more prosodic features from an audio sample, the one or more prosodic features indicative of one or more prosodic characteristics associated with human speech; and
classifying the audio sample as a deepfake audio sample or an organic audio sample by applying a machine learning model to the one or more prosodic features, wherein the machine learning model is configured as a classification-based detector for audio deepfakes.

2. The method of claim 1, wherein the classifying the audio sample comprises:
identifying the audio sample as the deepfake audio sample in response to the one or more prosodic features of the audio sample failing to correspond to a predefined organic audio classification measure as determined by the machine learning model.

3. The method of claim 1, wherein the extracting the one or more prosodic features comprises:
extracting the one or more prosodic features from a group comprising one or more pitch features, one or more intonation features, one or more jitter features, one or more fundamental frequency features, one or more shimmer features, one or more rhythm features, one or more stress features, one or more harmonic-to-noise ratio features, or one or more metrics features related to the one or more audio samples.

4. The method of claim 1, wherein the machine learning model is a neural network model.

5. The method of claim 1, wherein the machine learning model is a multilayer perceptron (MLP) model.

6. The method of claim 1, further comprising:
scaling the one or more prosodic features for processing by the machine learning model.

7. The method of claim 1, further comprising:
applying one or more hidden layers of the machine learning model to the one or more prosodic features.

8. An apparatus for detecting audio deepfakes through acoustic prosodic modeling, the apparatus comprising at least one processor and at least one memory including program code, the at least one memory and the program code configured to, with the at least one processor, cause the apparatus to at least:
extract one or more prosodic features from an audio sample, the one or more prosodic features indicative of one or more prosodic characteristics associated with human speech; and
classify the audio sample as a deepfake audio sample or an organic audio sample by applying a machine learning model to the one or more prosodic features, wherein the machine learning model is configured as a classification-based detector for audio deepfakes.

9. The apparatus of claim 8, wherein the at least one memory and the program code are configured to, with the at least one processor, further cause the apparatus to at least:
identify the audio sample as the deepfake audio sample in response to the one or more prosodic features of the audio sample failing to correspond to a predefined organic audio classification measure as determined by the machine learning model.

10. The apparatus of claim 8, wherein the at least one memory and the program code are configured to, with the at least one processor, further cause the apparatus to at least:
extract the one or more prosodic features from a group comprising one or more pitch features, one or more intonation features, one or more jitter features, one or more fundamental frequency features, one or more shimmer features, one or more rhythm features, one or more stress features, one or more harmonic-to-noise ratio features, or one or more metrics features related to the one or more audio samples.

11. The apparatus of claim 8, wherein the machine learning model is a neural network model.

12. The apparatus of claim 8, wherein the machine learning model is a multilayer perceptron (MLP) model.

13. The apparatus of claim 8, wherein the at least one memory and the program code are configured to, with the at least one processor, further cause the apparatus to at least:
scale the one or more prosodic features for processing by the machine learning model.

14. The apparatus of claim 8, wherein the at least one memory and the program code are configured to, with the at least one processor, further cause the apparatus to at least:
apply one or more hidden layers of the machine learning model to the one or more prosodic features.

15. A non-transitory computer storage medium comprising instructions for detecting audio deepfakes through acoustic prosodic modeling, the instructions being configured to cause one or more processors to at least perform operations configured to:
extract one or more prosodic features from an audio sample, the one or more prosodic features indicative of one or more prosodic characteristics associated with human speech; and
classify the audio sample as a deepfake audio sample or an organic audio sample by applying a machine learning model to the one or more prosodic features, wherein the machine learning model is configured as a classification-based detector for audio deepfakes.

16. The non-transitory computer storage medium of claim 15, wherein the operations are further configured to:
identify the audio sample as the deepfake audio sample in response to the one or more prosodic features of the audio sample failing to correspond to a predefined organic audio classification measure as determined by the machine learning model.

17. The non-transitory computer storage medium of claim 15, wherein the operations are further configured to:
extract the one or more prosodic features from a group comprising one or more pitch features, one or more intonation features, one or more jitter features, one or more fundamental frequency features, one or more shimmer features, one or more rhythm features, one or more stress features, one or more harmonic-to-noise ratio features, or one or more metrics features related to the one or more audio samples.

18. The non-transitory computer storage medium of claim 15, wherein the machine learning model is a multilayer perceptron (MLP) model.

19. The non-transitory computer storage medium of claim 15, wherein the operations are further configured to:
scale the one or more prosodic features for processing by the machine learning model.

20. The non-transitory computer storage medium of claim 15, wherein the operations are further configured to:
apply one or more hidden layers of the machine learning model to the one or more prosodic features.
